(19) United States
(12) Patent Application Publication
(10) Pub. No.: US 2007/0232220 A1
(43) Pub. Date: Oct. 4, 2007

(54) Private civil defense-themed broadcasting method

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/461,605

(22) Filed: Aug. 1, 2006

Related U.S. Application Data
(63) Continuation-in-part of application No. 11/384,037, filed on Mar. 17, 2006.

(51) Int. Cl. H04H 1/00

(52) U.S. Cl. 455/3.01

(57) ABSTRACT

One provides (101) a plurality of private civil defense audio programs, wherein various ones of the plurality of private civil defense audio programs provide private civil defense information regarding both naturally-caused and non-naturally-caused civilly-catastrophic events. Taken in the aggregate, this private civil defense information (102) comprises information regarding various elements of a proactive private civil defense posture. One or more dedicated private civil defense-themed radio broadcast channels are then employed to transmit (103) these programs.

### RELATED APPLICATIONS

This comprises a continuation-in-part of:

SUBSCRIPTION-BASED PRIVATE CIVIL SECURITY FACILITATION METHOD as filed on Mar. 17, 2006 and having application Ser. No. 11/384,037;

subscription-based catastrophe-triggered medical services facilitation method as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333;

RADIATION SHELTER KIT APPARATUS AND METHOD as filed on Apr. 24, 2006 and having application Ser. No. 11/379,929;

FRACTIONALLY-POSSESSED UNDERGROUND SHELTER METHOD AND APPARATUS as filed on May 2, 2006 and having application Ser. No. 11/381,247;

SUBSCRIPTION-BASED CATASTROPHE-TRIGGERED TRANSPORT SERVICES FACILITATION METHOD AND APPARATUS as filed on May 2, 2006 and having application Ser. No. 11/381,257;

SUBSCRIPTION-BASED MULTI-PERSON EMERGENCY SHELTER METHOD as filed on May 2, 2006 and having application Ser. No. 11/381,265; and

SUBSCRIPTION-BASED CATASTROPHE-TRIGGERED RESCUE SERVICES FACILITATION METHOD AND APPARATUS as filed on May 2, 2006 and having application Ser. No. 11/381,277;

DOCUMENT-BASED CIVILLY-CATASTROPHIC EVENT PERSONAL ACTION GUIDE FACILITATION METHOD as filed on May 12, 2006 and having application Ser. No. 11/383,022;

RESCUE CONTAINER METHOD AND APPARATUS as filed on May 26, 2006 and having application Ser. No. 11/420,594;

PURCHASE OPTION-BASED EMERGENCY SUPPLIES PROVISIONING METHOD as filed on Jun. 1, 2006 and having application Ser. No. 11/421,694;

SUBSCRIPTION-BASED PRE-PROVISIONED TOWABLE UNIT FACILITATION METHOD as filed on Jun. 12, 2006 and having application Ser. No. 11/423,594;

RADIATION-BLOCKING BLADDER APPARATUS AND METHOD as filed on Jun. 19, 2006 and having application Ser. No. 11/425,043; and

PRIVATE CIVIL DEFENSE-THEMED TELEVISION BROADCASTING METHOD as filed on Jun. 23, 2006 and having application Ser. No. 11/426,231;

EMERGENCY SUPPLIES PRE-POSITIONING AND ACCESS CONTROL METHOD as filed on Jul. 10, 2006 and having application Ser. No. 11/456,472; the contents of which are fully incorporated herein by this reference.

### TECHINCAL FIELD

This invention relates generally to providing survival-related services.

### BACKGROUND

Many citizens of the world have long passed the point when a ready availability of the basic necessities of life is satisfactory in and of itself. Today's consumer-oriented citizens demand, and often receive, an incredibly diverse and seemingly ever-growing cornucopia of consuming and experiential options. Such riches are typically based, in turn, upon a highly interdependent series of foundational infrastructure elements. Examples of the latter include, but are certainly not limited to:

transportation infrastructure such as roads, bridges, railways, and so forth that facilitate the inexpensive and rapid movement of sometimes perishable goods from source to consumer;

communications infrastructure such as telephones, television, radio, and the Internet that facilitate the inexpensive and rapid sharing of news, advice, information, and entertainment; and

the totality of civil services such as police services, fire fighting services, medical services, and so forth that facilitate a sufficient degree of order and predictability to, in turn, permit the complex series of inter-related actions that modern society requires in order to operate.

As powerful as the machinery of modern life appears, however, modern citizens are today perhaps more at risk of experiencing a serious disruption in their ability to prosper or even to survive en mass than is generally perceived. Providing the necessities of life in general requires a lot of things to all operate, more or less, correctly. To put it another way, a serious disruption to any significant element of civilized infrastructure can produce catastrophic results for a broad swath of a given civil entity. Any number of natural and/or non-naturally-caused events can greatly disrupt society's infrastructure and corresponding ability to provide one or more life-sustaining resources such as water, nutrition, shelter, and the like.

Many people believe and trust that their government (local, regional, and/or national) will reliably assist them with respect to predicting civilly-catastrophic events and provide for them in the event of such a civilly-catastrophic event. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to reliably predict and/or anticipate the impact of a given civilly-catastrophic event or to respond, before or after the fact, to even basic survival needs when a civilly-catastrophic event occurs. To a large extent one may reasonably argue that many modern governments have forsaken their responsibility to design, fund, implement, or even discuss an effective civil defense program capable of protecting large segments of their populations.

Such insights, of course, are not particularly new. Civil preparedness shortcomings occasionally attract public attention and niche marketing opportunities exist with respect to provisioning the needs of so-called survivalists. Indeed, there are those who spend a considerable amount of their time and monetary resources attempting to ready themselves to personally survive a civilly-catastrophic event. Therein, however, lies something of a conundrum.

On the one hand, many modern governments typically do little to proactively ensure the bulk survival (let alone the comfort) of their citizens in the face of most civilly-catastrophic events. Governmental authorities often provide insufficient (or late) information regarding civil threats of various kinds. Concerned individuals often find themselves with insufficient information regarding specific threats in this regard, including the existence of the threat, the characterizing nature of the threat, meaningful actions that one can take to better ensure one's own survival in the face of the threat, and so forth.

On the other hand, attempting to take responsible actions to independently obtain such information can become, in and of itself, nearly a full-time avocation and leave little time to actually enjoy the conveniences and opportunities of modern life. Such individual actions may even be frowned upon by the greater part of society which has grown accustomed and falsely secure with existing efficient just-in-time delivery systems that provide the illusion of plenty while undercutting the perception of risk.

### BRIEF DESCRIPTION OF THE DRAWINGS

The above needs are at least partially met through provision of the private civil defense-themed broadcasting method described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a top plan block diagram view as configured in accordance with various embodiments of the invention;

FIG. 4 comprises a flow diagram as configured in accordance with various embodiments of the invention; and

FIG. 5 comprises a flow diagram as configured in accordance with various embodiments of the invention.

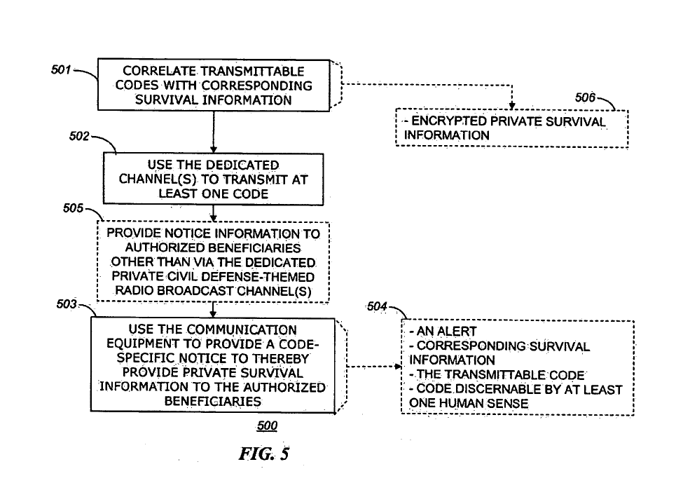

Skilled artisans will appreciate that elements in the figures are illustrated for simplicity and clarity and have not necessarily been drawn to scale. For example, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one provides a plurality of private civil defense audio programs, wherein various ones of the plurality of private civil defense audio programs provide private civil defense information regarding both naturally-caused and non-naturally-caused civilly-catastrophic events. Taken in the aggregate, this private civil defense information comprises information regarding various elements of a proactive private civil defense posture. Examples in this regard include, but are not limited to, information regarding characterizing attributes as pertain to various civilly-catastrophic events, general actions that individuals in general can take to better prepare to improve their chances of surviving a given civilly-catastrophic event, likelihoods of specific civilly-catastrophic events occurring, and specific recommendations for specific individuals (including but not limited to authorized beneficiaries of consideration-based private civil security subscriptions that provide civilly-catastrophic event-based access to at least one life-sustaining resource).

One or more dedicated private civil defense-themed radio broadcast channels are then employed to transmit this plurality of private civil defense audio programs. By one approach, if desired, these teachings can be used in conjunction with transmittable codes that are correlated to corresponding survival information. Such codes can serve to facilitate the conveyance of private survival information to specific listeners such as the aforementioned authorized beneficiaries. In some instances, these teachings will accommodate transmitting the plurality of private civil defense audio programs using non-terrestrial radio transmission equipment (such as satellites, aircraft, or balloons and the like equipped with transmitters and so forth).

So configured, general program recipients will be able to become generally better informed regarding various civilly-catastrophic threats and to be generally better prepared to more predictably and reliably survive a variety of such threats. In addition, authorized beneficiaries as noted above will be able to reliably and predictably receive specific information regarding recommended actions as correspond to their consideration-based private civil security subscriptions. Accordingly, the individuals comprising the listening audience can take important steps to bring a considerably improved measure of security into their lives without having to effectively become a full-time survivalist; such individuals can, in short, continue to enjoy their chosen vocations and standard of living knowing that, should a civilly-catastrophic event indeed be visited upon them, they will have had extraordinary access to one or more preparatory informational resources that will greatly enhance their survival opportunities.

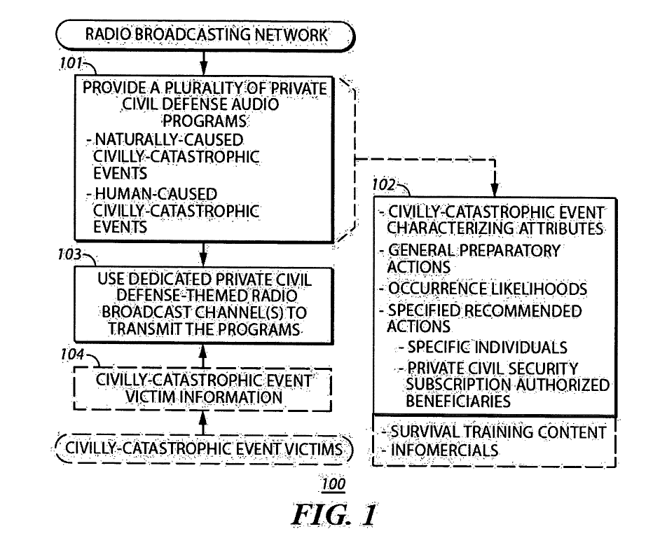

These and other benefits may become clearer upon making a thorough review and study of the following detailed description. Referring now to the drawings, and in particular to FIG. 1, these teachings provide a process 100 to facilitate the provisioning of a radio broadcasting network with private civil defense-related content. This process 100 comprises providing 101 a plurality of private civil defense audio programs, wherein various ones of the plurality of private civil defense audio programs provide private civil defense information regarding naturally-caused civilly-catastrophic events as well as non-naturally-caused civilly-catastrophic events.

As used herein, “civilly-catastrophic event” will be understood to refer to an event that substantially and materially disrupts a society's local, regional, and/or national infrastructure and ability to provide in ordinary course at least one life-sustaining resource. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation of that interruption.

A civilly-catastrophic event can be occasioned by any of a wide variety of natural and/or non-naturally-caused disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, and so forth), extreme geological events (such as earthquakes, volcanic activity, and so forth), extreme astronomical events (such as Earthly collisions with comets, large asteroids, and so forth, extreme solar flares, and so forth), extreme environmental events (such as widespread uncontrolled fire, a rapidly and/or widely dispersed unduly invasive species, and so forth), and global or regional pandemics, to note but a few.

Examples of non-naturally-caused disasters capable of initiating a civilly-catastrophic event include both unintended events as well as intentional acts of war, terrorism, madness, or the like. Examples of non-naturally-caused disasters capable of such potential scale include, but are not limited to, nuclear-related events (including uncontrolled fission or fusion releases, ionizing radiation exposure, and so forth), acts of war, the release of deadly or otherwise disruptive biological, mechanical, electrical, and/or chemical agents or creations, and so forth.

In the aggregate 102, this private civil defense information can comprise, at least in part, information regarding characterizing attributes regarding various civilly-catastrophic events (such as their causes, their immediate and longer term effects and impact, their relative short term and long term likelihoods of occurring, and ways by which such events may be personally anticipated), general actions that individuals in general can take to better prepare to at least survive given civilly-catastrophic events (such as particular supplies to pre-provision, specific attributes of sheltering or other protective actions that one may take, and particular behaviors to adopt or encourage and/or skills to acquire to better facilitate one's own chances of surviving such an event), likelihoods of specific civilly-catastrophic events occurring (as specified, for example, with respect to various relevant risk criteria such as geography, time, season, political and/or religious affiliation, racial and/or cultural standing or affinity, and so forth), specific recommended actions for specific individuals with respect to a present civilly-catastrophic event scenario (such as, for example, those individuals who reside within a particular denoted geographic area), and so forth.

This private civil defense information 102 can also comprise specific recommended actions for authorized beneficiaries of consideration-based private civil security subscriptions that provide civilly-catastrophic event-based access to at least one life-sustaining resource. The latter can comprise, for example, resources that pertain to hydration, nourishment, shelter, environmentally borne threat abatement (such as protection from chemical, biological, and/or radioactive threats and the like), transportation, and/or rescue services. As used herein, the term “subscription” shall be understood to refer to and encompass a variety of legal mechanisms. Some relevant examples include, but these teachings are not limited to, subscription mechanisms such as:
time-limited rights of access (as where a subscription provides access rights for a specific period of time, such as one year, in exchange for a corresponding series of payments);
event-limited rights of access (as where a subscription provides access rights during the life of a given subscriber based upon an up-front payment in full and where those access rights terminate upon the death of the subscriber or where, for example, a company purchases a subscription for a key employee and those corresponding rights of access terminate when and if that key employee leaves the employment of that company);
inheritable rights of access (as may occur when the subscription, by its own terms and conditions, provides a right of access that extends past the death of a named subscription beneficiary and further allows for testate and/or intestate transfer to an heir);
rights of access predicated upon a series of periodic payments (as where a subscription provides access rights during, for example, predetermined periods of time on a periodic basis as where a subscriber offers month-by-month payments to gain corresponding month-by-month access rights);
rights of access predicated upon a one-time payment (as may occur when a subscriber makes a single payment to obtain a time-based or event-based duration of access rights or, if desired, when a single payment serves to acquire a perpetual right of access that may be retained, transferred, inherited, or the like);
ownership-based rights of access (as may occur when the subscription provides for ownership rights in the at least one life-sustaining resource);
non-transferable rights of access (as may occur when the subscription, by its terms and conditions, prohibits transfer of the right of access to the at least one life-sustaining resource from a first named beneficiary to another);
transferable rights of access (as may occur when the subscription, by its terms and conditions, permits conditional or unconditional transfer of the right of access to the at least one life-sustaining resource from a first named beneficiary to another);
membership-based rights of access (as may occur when the subscription, by its terms and conditions, establishes a membership interest with respect to the accorded right of access such as, for example, a club-based membership);
fractionally-based rights of access (as may occur when the subscription, by its terms and conditions, establishes a divided or undivided co-ownership interest by and between multiple subscription beneficiaries with respect to a right to access the at least one life-sustaining resource); and/or
non-ownership-based rights of access (as may occur when the subscription, by its terms and conditions, establishes the aforementioned right of access via, for example, a lease, rental, or borrowing construct).

There are various ways by which such programs can be provided. By one approach, for example, this step can comprise, at least in part, gathering information regarding past, present, and potential civilly-catastrophic events from various sources (including both public and private sources as desired and available) and using that information to provide the aforementioned plurality of private civil defense audio programs. This step may also comprise, if desired, the use of new original research to develop new information in this regard.

Various kinds of private civil defense audio programs can be employed in this regard. For example, by one approach, these programs can comprise one or more of a natural history program (to present, for example, relevant historical examples), a scientific study (to present, for example, the facts and figures as pertain to the causes, effects, and/or enabling technologies of various kinds of civilly-catastrophic events), and/or a political study as relates to one or more categories, kinds, and/or examples of civilly-catastrophic events. As another example, if desired, these programs can comprise one or more programs that deal instead with preparation and survival information. Illustrative examples in this regard would include, but are not limited to:

a program that identifies particular supplies that are useful to obtain prior to a civilly-catastrophic event to better facilitate surviving that civilly-catastrophic event (where illustrative examples in this regard might include particular foods, consumable liquids, medicines and medical supplies, clothing, airborne threat abatement apparatus, shelter construction materials, vehicles, self-defense equipment, tools (including but not limited to food preparation tools and equipment), communications equipment, power sources, personal hygiene products, lighting equipment, barter medium, pet supplies, and so forth);

a program that identifies particular suppliers of recommended survival supplies;

a program that identifies particular precautions to take to better facilitate surviving a civilly-catastrophic event (ranging, for example, from how to maintain a fresh and current stockpile of supplies and how to fashion a shelter to provide protection from one or more kinds of civilly-catastrophic events to planning one or more evacuation routes and establishing a post-event protocol that group members can employ to locate one another); and

a program that identifies recommended usage of survival-related supplies when surviving a civilly-catastrophic event (including, for example, such topics as a recommended order of usage, rationing criteria and plans, equipment and tool instructions, first aid training, pharmacological strategies, and so forth);

to note but a few.

Other programs may also be offered in this regard. As one example in this regard, one or more programs that present a fictional representation of a civilly-catastrophic event can be offered. By one approach this programming can primarily serve as an entertainment feature. By another approach, such programming can more primarily serve as a kind of informational and/or training medium with any entertainment value comprising a secondary purpose.

As another example in this regard, such programming can comprise one or more programs that present a simulation of such content as a civilly-catastrophic event. Such simulations can serve as stand-alone programming or can comprise a part of other programming options as have been identified herein. By one approach the simulation can relate instead to civilly-catastrophic event-based listener-actionable precautionary actions. So configured, the simulation content can serve as an instructional and/or advisory mechanism regarding specific actions that listeners can themselves implement to better prepare themselves to survive a civilly-catastrophic event. By yet another approach the simulation can relate instead to post-civilly-catastrophic event-based listener actionable survival-enhancing actions. So configured, the simulation content can serve as an instructional and/or advisory mechanism regarding specific actions that listeners can themselves implement to better navigate the challenges that will likely follow the occurrence of a given civilly-catastrophic event.

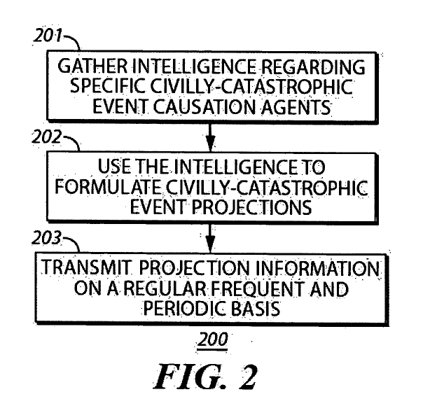

As noted above, the provided programming can comprise, in part, information regarding likelihoods of specific civilly-catastrophic events occurring. There are various ways to facilitate the provision of such information. As one illustrative example in this regard, and referring momentarily to FIG. 2, one useful process 200 would provide for gathering 201 intelligence regarding specific civilly-catastrophic event causation agents. These can comprise, for example, naturally-caused civilly-catastrophic event agents such as extreme weather events, extreme geologic events, and so forth. These can also comprise, if desired, agents other than naturally-caused civilly-catastrophic event agents. Examples in this regard might include, but are certainly not limited to, prompting or sustaining agents regarding political, religious, ethnic, or other kinds of social unrest.

This process 200 then provides for using 202 the intelligence, at least in part, to formulate civilly-catastrophic event projections. Various intelligence factors can of course be applied in this regard. Some relevant examples would include, but are not limited to, information regarding the likely magnitude of impact of a given potential civilly-catastrophic event (with events of greater likely civil magnitude, for example, perhaps more likely garnering a projection mention notwithstanding a present relatively low likelihood of occurring), existing weather conditions, predicted weather conditions, seasonal-based conditions (as may pertain, for example, to climate, individual and/or crowd behaviors, traffic conditions, supplies and commodities availability, disease vectors and patterns, and so forth), geographic circumstances, a time of day, population size, and so forth.

This process 200 then provides for using 203 the aforementioned dedicated private civil defense-themed radio broadcast channel (or channels) to transmit information regarding these civilly-catastrophic event projections. Such broadcasts can be offered in a relatively unsynchronized and/or irregular manner or, if desired, can be transmitted on a regular relatively frequent and periodic basis. As one illustrative example of the latter, projection information regarding local projected threats could be provided every fifteen minutes. If desired, this could additionally include providing the projection information notwithstanding a present relatively low likelihood of a civilly-catastrophic event occurring. Such projections could be provided during transitions from one program to another, as an interruption during a given program, or as co-provided content during the presentation of another program.

By one approach, such intelligence is used to formulate civilly-catastrophic event projections that are local to a particular limited geographic area (such as a given city (or portion of a given city), county, state, or the like). In such a case, the aforementioned transmission step can comprise broadcasting civilly-catastrophic event projections as are localized by content to a particular limited geographic area in a limited manner that tends to include listeners who are located within that limited geographic area while tending to exclude listeners who are located outside that particular geographic area. So configured, listeners would tend to receive threat projection information of particular personal relevance while not necessarily being similarly exposed to less relevant information.

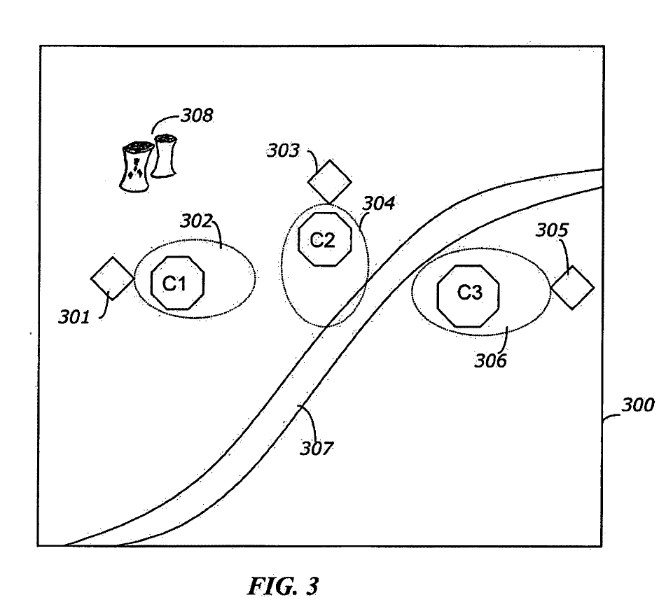

As one example, and referring to FIG. 3, this could be accomplished in a given geographic area 300 with the use of one or more local coverage radio broadcast stations 301, 303, and 305, the coverage area for each such local coverage radio broadcast station 301, 303, and 305 being denoted by reference numerals 302, 304, and 305, respectively. In this illustrative example there are two potential civilly catastrophic threats, a frequently flooding river 307 and a nuclear power plant 308. There are also three areas of dense population referred to by C1, C2 and C3, each within the coverage area 302, 304, and 306 of a separate local coverage broadcast station 301, 303, and 305 respectively. The local coverage broadcast station 301 that is proximate to only the nuclear power plant 308 can transmit projections about the threat of release of radiation from that plant 308. The local coverage broadcast station 305 that is proximate only to the river 307 can transmit projections relevant to flooding of the river 307. And the station 303 that is proximate to both the river 307 and the plant 308 can transmit projections about the threats of both a release of radiation from the plant 308 and flooding of the river 307.

Referring again to FIG. 1, as noted above, the provided programming can comprise, if desired, programming that represents specific recommended actions for specific individual listeners. This can comprise, for example, information that is specifically targeted for individuals who comprise persons who are presently located within a particular geographic area (such as a metropolitan area or some portion thereof). As one example in this regard, the information may comprise detailed information regarding specific geographic areas affected by an immediate civilly-catastrophic event (such as specific affected areas, landmarks, addresses, blocks, residential subdivisions, geographic coordinates and so forth). As another example, the information may comprise evacuation routing recommendations and the individuals may comprise persons who are within the area to which the evacuation routing instructions particularly apply.

Those skilled in the art will understand and appreciate that such evacuation instructions may be provided during a time of immediate need but may also be provided prior to the need actually arising. For example, such information can be provided from time to time in order to keep listeners apprised of what evacuation route they could or should use in the event a civilly-catastrophic event (whether anticipated or not) occurs. This can be particularly important, for example, in event scenarios where radio broadcasting and/or reception may be partially or fully disabled during an actual time of need.

As another example, this target content may comprise information for persons who have a particular cultural (such as, but not limited to, political, ethnic, racial, or the like) affiliation, religious affiliation, economic status, or the like. Other bases and criteria for targeting particular programming for particular listeners may of course be considered and applied in accordance with the needs, requirements, and/or options presented by a given application setting.

As noted earlier, at least some of the provided programming content can comprise survival training content (such as lessons, instructions, educational material, content regarding mental preparedness, and so forth), . By one approach, if desired, this survival training content can be specifically formed, delivered, and/or intended for authorized beneficiaries of consideration-based private civil security subscriptions as described above. Viewed generally, for example, such survival training content could serve to facilitate an ability of the authorized beneficiaries to better comply with the terms and conditions of their subscriptions.

This could comprise, for example, receiving training that will enable such listeners to better receive the benefits of services as are provided pursuant to such subscriptions. To illustrate, such survival training content could comprise information regarding the contents, storage, and usage of survival-related supplies as are provided to the authorized beneficiaries pursuant to their subscriptions, locating, boarding, and traveling in pre-arranged subscription-based transport, how to cooperate with rescue personnel to aid with effecting one's own rescue and/or extraction, shelter facilities and recommended behaviors, and so forth.

If desired, such survival training content could serve to facilitate an ability of subscribers to such subscriptions to receive reduced-consideration private civil security subscriptions. As described in the aforementioned PERSONAL PROFILE-BASED PRIVATE CIVIL SECURITY SUBSCRIPTION METHOD patent application as filed on Apr. 11, 2006 and having application Ser. No. 11/279,333, documented or certified training can serve as a basis for reduced-cost subscriptions. Such a reduction is based upon the primary notion that a well-trained authorized beneficiary will be easier to handle and care for during a time of need. Therefore, at least some of the provided programming can comprise training materials that can be used by authorized beneficiaries when working to receive a requisite quantity of instruction in this regard.

As noted above, the provided programming can comprise, in part, information regarding recommended survival materials and activities. Somewhat in this regard, if desired, this process 100 will further optionally accommodate including corresponding relevant infomercials in such programming. Illustrative examples in this regard would include (but are not limited to) infomercials regarding civilly-catastrophic event-related survival supplies, civilly-catastrophic event-related survival apparatus, civilly-catastrophic event-related survival plans, and/or civilly-catastrophic event-related survival services (including, for example, virtual tours of private civil defense shelter facilities, explanation of emergency private transport and/or rescue services, and so forth), to note but a few. A somewhat related programming concept would be a product/service rating program where survival-related products and/or services are explained, tested, vetted, and ranked or rated with respect to their efficacy, use, pluses, minuses, and relative value.

To facilitate the transmission of information and programs to the authorized beneficiaries, it may be desirable to provide the authorized beneficiaries with communication equipment (such as a radio receiver, satellite radio receiver, specially configured cellular telephone, specially configured personal data assistant, and so forth) operable to receive at least one dedicated private civil defense-themed radio broadcast channel. By one approach, the communication equipment may be used for reception only. By another approach, the communication equipment may be used to facilitate two-way communication between the authorized beneficiary and other persons (such as other authorized beneficiaries, a private civil-defense service, a public emergency service, a public member, and so forth). If desired, the communication equipment may be integrated into one or more other devices or apparatuses such as a container, an article of clothing, a vehicle, a personal or laptop computer, another communication device, a shelter, civil-defense related items and so forth. The communication equipment may be put to additional specific uses, some of which are detailed herein.

If desired, this process 100 will also optionally accommodate receiving 104 civilly-catastrophic event victim information from such victims and then using 103 the above mentioned dedicated private civil defense-themed radio broadcast channel(s) to transmit such civilly-catastrophic event victim information. Such transmissions could, if desired, be presented in tandem with other private civil defense audio programs as are broadcast by the radio broadcasting network. By one approach, this could be accomplished by providing authorized beneficiaries with the aforementioned communication equipment operable to receive at least one dedicated private civil defense-themed broadcast channel, and using the communication equipment to present the victim information visually (such as with a scrolling marquee, a display screen and so forth). Such information regarding the victim could comprise, for example, identification information, health condition information, present (or future) contact information, present (or future) location information, environmental condition information, preferred destination information, evacuation plan information and so forth and might serve, for example, to aid in facilitating communications amongst a given group of authorized beneficiaries of the aforementioned subscriptions. Such information could be received from authorized beneficiaries using the aforementioned communication equipment operable to receive at least one private-civil defense themed radio broadcast channel, or other communication means (such as a telephone, two-way radio, e-mail or other Internet based communication and so forth) provided to the authorized beneficiaries.

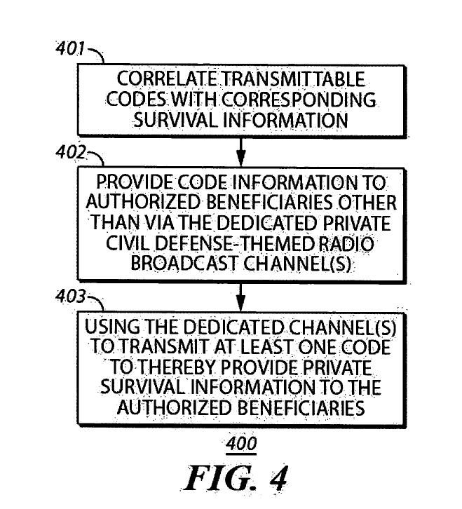

The aforementioned network facilities can also be used, if desired, to facilitate communications with, for example, authorized beneficiaries of such subscriptions in a way such that at least some content of the private survival information is not discemable by the general program recipients. If desired, this can comprise transmitting private survival information while also transmitting one of the aforementioned private civil-defense audio programs. By one method, this can be achieved by coded communication. To illustrate, and referring now to FIG. 4, a corresponding process 400 can provide for correlating 401 transmittable codes with corresponding survival information. Such transmittable codes may comprise audible codes (such as articulated alphanumeric sequences, one or more tones, specific melodies, and so forth), and/or codes that are not discemable by any ordinary human senses (such as sub-audible or ultrasonic sounds, phase modulation, ducking, and so forth.).

The aforementioned corresponding survival information as is correlated with such transmittable codes can comprise any useful information in this regard including, but not limited to, instructions to act in a specific manner or to do something in particular. As one example, a first code might serve to notify a particular pre-identified group of authorized beneficiaries of a heightened likelihood regarding a need to evacuate. As another example, a second code might serve to notify a particular pre-identified group of authorized beneficiaries of the initiation of a training exercise.

This process 400 then provides 402 such information to the authorized beneficiaries other than via the dedicated private civil defense-themed radio broadcast channel(s). For example, such information can be provided via delivery of hardcopy to the intended recipients, via facsimile transmission, via email, as downloadable content at a secure password protected Web site, and so forth. The purpose of this step is to provide the authorized beneficiaries with the information that they will need to decode such codes when and if these codes are actually transmitted.

This process 400 then provides for using 403 the dedicated private civil defense-themed radio broadcast channel to transmit at least one of the transmittable codes to thereby provide private survival information to the authorized beneficiaries.

By a similar method 500, the process could involve using the aforementioned communication equipment 503 (such as with the use of transmittable codes, modulation of the private survival information, and so forth). By one method, transmittable codes could be correlated with the private survival information as mentioned above 501. Upon receiving one of the transmittable codes, the communication equipment could provide the authorized beneficiaries with a code-specific notice 503. The code-specific notice could comprise 504 an alert (such as illuminating a light, emitting an audible tone, vibrating and so forth), providing the corresponding survival information, relaying the transmittable code, or providing a code that is discernable by at least one ordinary human sense (such as visible codes, audible codes, tactile or vibratory codes and so forth). If desired, information regarding the code-specific notice could be provided 505 to the authorized beneficiaries other than via the dedicated private civil defense-themed radio broadcast channel (such as via hardcopy delivery, facsimile transmission, email, download from a password protected Web site, and so forth) so that the authorized beneficiaries can discern the meaning of a code-specific notice that is not self-descriptive. By an alternative method, the transmittable code comprises 506 encrypted private survival information, and the communication equipment is configured and arranged to decrypt the transmittable codes.

Other possibilities exist. For example, by one approach, the listener's radio receiver may be pre-provisioned with other survival-related content (which content may be audible only or may have a visual component as well or in lieu thereof). Such content may, in turn, be correlated to specific codes. So configured, such supplemental content could be automatically rendered available to the listener upon receipt of the requisite code via the aforementioned radio broadcasts. Such survival-related content could be general in nature or could be highly customized for the individual listener. For example, an authorized beneficiary of a subscription as described above could have their receiving device(s) pre-provisioned with individual specific actions that should be carried out by that person in the event of a civilly-catastrophic event. Examples of such information may be found in the aforementioned patent application entitled DOCUMENT-BASED CIVILLY-CATASTROPHIC EVENT PERSONAL ACTION GUIDE FACILITATION METHOD. To the extent that a given receiver contains such information, of course, it would also be possible to permit the listener to gain access to such content in more direct ways such as via a corresponding user interface that provides for content navigation functionality.

It may be desirable to enhance the content of the private civil defense audio programs by providing supplemental programming other than via the dedicated private civil defense-themed radio broadcast channel. This supplemental programming could be provided in a media other than purely audio (such as visual, audiovisual, and so forth), and could be provided by a television broadcast such as the one described in the aforementioned PRIVATE CIVIL DEFENSE-THEMED TELEVISION BROADCASTING METHOD patent application, or conveyed by other media (such as with printed media, a computer based network, other television broadcasts and so forth). It may be additionally desirable for a given private civil defense-themed audio program to provide information about the supplemental programming, for example by directing the listener to the supplemental programming during the program.

It will be appreciated that these teachings provide for a highly flexible yet powerfully effective way by which a modem citizen can receive information that will greatly improve their likelihood of surviving a civilly-catastrophic event. These teachings are sufficiently flexible so as to accommodate the needs and desires of a wide-ranging set of potential beneficiaries. The listeners of such programming will of course increase their theoretical and practical knowledge of the aforementioned topics. It might also be expected, however, that the existence of such a network and the nature of its content will help to more generally increase both a relative level of dialogue and awareness regarding these topics in society at large as well as the practical ability of individuals and organizations to better survive civilly-catastrophic events when and as such events occur.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As one example in this regard, the aforementioned programs can further comprise a program that presents instructions regarding specific actions that a listener can take with respect to a given civilly-catastrophic event (such as, for example, an imminent civilly-catastrophic event) in a relatively immediate timeframe. To illustrate, this can comprise a program that presents instructions regarding formulation of an emergency shelter that the listener can form using substantially only commonly available household items (such as, but not limited to, mattresses, specific items of furniture, expandable caulking, adhesive tape, bathtubs, and so forth) to thereby facilitate near-term preparation of such a shelter. As a further example taking advantage of the portability of radio devices, this can comprise a program presenting instructions for survival in a wilderness environment. Such information, provided at a time of need (or just prior thereto) would facilitate allowing listeners to better protect themselves from a given civilly-catastrophic event.

I claim:

1. A method comprising:
providing a plurality of private civil defense audio programs, wherein various ones of the plurality of private civil defense audio programs provide private civil defense information regarding:
naturally-caused civilly-catastrophic events; and
non-naturally-caused civilly-catastrophic events;
and wherein the private civil defense information in aggregation comprises, at least in part, information regarding:
characterizing attributes regarding the civilly-catastrophic events;
general actions that individuals in general can take to better prepare to at least survive given civilly-catastrophic events;
likelihoods of specific civilly-catastrophic events occurring;
specific recommended actions for specific individuals with respect to a present civilly-catastrophic event scenario;
specific recommended actions for authorized beneficiaries of consideration-based private civil security subscriptions that provide civilly-catastrophic event-based access to at least one life-sustaining resource;
using at least one dedicated private civil defense-themed radio broadcast channel to transmit the plurality of private civil defense audio programs, such that general program recipients are able to:
become generally informed regarding various civilly-catastrophic threats;
become generally better prepared to more predictably and reliably survive various civilly-catastrophic threats;
and such that the authorized beneficiaries are able to reliably and predictably receive specific information regarding recommended actions as correspond to their consideration-based private civil security subscriptions.

2. The method of claim 1 wherein providing a plurality of private civil defense audio programs comprises providing at least one of:
a natural history program regarding a civilly-catastrophic event;
a scientific study regarding a civilly-catastrophic event;
a political study regarding a civilly-catastrophic event.

3. The method of claim 1 wherein providing a plurality of private civil defense audio programs comprises providing at least one of:
a program that identifies particular supplies that are useful to obtain prior to a civilly-catastrophic event to better facilitate surviving a civilly-catastrophic event;
a program that identifies particular suppliers of recommended survival supplies;
a program that identifies particular precautions to take to better facilitate surviving a civilly-catastrophic event;
a program that identifies recommended usage of survival-related supplies when surviving a civilly-catastrophic event.

4. The method of claim 1 wherein providing a plurality of private civil defense audio programs comprises providing a program presenting a fictional representation of a civilly-catastrophic event.

5. The method of claim 1 wherein providing a plurality of private civil defense audio programs comprises providing a program presenting a simulation of at least one of:
a civilly-catastrophic event;
civilly-catastrophic event-based listener-actionable precautionary actions;
post-civilly-catastrophic event-based listener actionable survival-enhancing actions.

6. The method of claim 1 wherein providing a plurality of private civil defense audio programs comprises providing a program presenting evacuation routing recommendations.

7. The method of claim 6 wherein providing a program presenting evacuation routing recommendations comprises providing a program presenting evacuation routing recommendations on a regular periodic basis.

8. The method of claim 7 wherein providing a program presenting evacuation routing recommendations on a regular periodic basis comprises providing a program presenting evacuation routing recommendations on a regular periodic basis notwithstanding a present relatively low likelihood of a civilly-catastrophic event-necessitated evacuation being considered necessary.

9. The method of claim 1 wherein the information regarding specific recommended actions for specific individuals with respect to a present civilly-catastrophic event scenario comprises, at least in part, information specifically targeted for individuals who comprise at least one of:
individuals within a particular geographic area;
individuals of a particular cultural affiliation;
individuals of a particular religious affiliation;
individuals of a particular economic affiliation.

10. The method of claim 1 further comprising:
using the at least one dedicated private civil defense-themed radio broadcast channel to transmit infomercials regarding at least one of:
civilly-catastrophic event-related survival supplies;
civilly-catastrophic event-related survival apparatus;
civilly-catastrophic event-related survival plans;
civilly-catastrophic event-related survival services.

11. The method of claim 1 further comprising:
gathering intelligence regarding specific civilly-catastrophic event causation agents;
using the intelligence, at least in part, to formulate civilly-catastrophic event projections;
using the at least one dedicated private civil defense-themed radio broadcast channel to transmit information regarding the civilly-catastrophic event projections.

12. The method of claim 11 wherein using the at least one dedicated private civil defense-themed radio broadcast channel to transmit information regarding the civilly-catastrophic event projections comprises transmitting the information regarding the civilly-catastrophic event projections on a regular relatively frequent and periodic basis.

13. The method of claim 12 wherein transmitting the information regarding the civilly-catastrophic event projections on a regular relatively frequent and periodic basis comprises transmitting the information regarding the civilly-catastrophic event projections on a regular relatively frequent and periodic basis notwithstanding a present relatively low likelihood of a civilly-catastrophic event occuring.

14. The method of claim 11 wherein:
using the intelligence, at least in part, to formulate civilly-catastrophic event projections comprises using the intelligence to formulate civilly-catastrophic event projections that are local to a particular limited geographic area;
using the at least one dedicated private civil defense-themed radio broadcast channel to transmit information regarding the civilly-catastrophic event projections comprises broadcasting the civilly-catastrophic event projections that are local to a particular limited geographic area in a limited manner that tends to include listeners within the particular limited geographic area and exclude listeners outside the particular limited geographic area.

15. The method of claim 14 wherein the limited manner that tends to include listeners within the particular limited geographic area and exclude listeners outside the particular limited geographic area comprises broadcasting the civilly-catastrophic event projections that are local to a particular limited geographic area from at least one local coverage radio broadcast station.

16. The method of claim 11 wherein gathering intelligence regarding specific civilly-catastrophic event causation agents comprises gathering intelligence regarding specific civilly-catastrophic event causation agents other than naturally-caused civilly-catastrophic event agents.

17. The method of claim 11 wherein using the intelligence, at least in part, to formulate civilly-catastrophic event projections comprises, at least in part, using intelligence regarding at least one of the following:
a likely magnitude of impact of a given potential civilly-catastrophic event;
existing weather conditions;
predicted weather conditions;
seasonal-based conditions;
geographic circumstances;
a time of day;
population size.

18. The method of claim 1 further comprising:
providing survival training content.

19. The method of claim 18 wherein providing survival training content comprises providing survival training content specifically designed for the authorized beneficiaries of consideration-based private civil security subscriptions that provide civilly-catastrophic event-based access to at least one life-sustaining resource to facilitate an ability of the authorized beneficiaries to better comply with terms and conditions of the consideration-based private civil security subscriptions.

20. The method of claim 18 wherein providing survival training content comprises providing survival training content specifically designed for the authorized beneficiaries of consideration-based private civil security subscriptions that provide civilly-catastrophic event-based access to at least one life-sustaining resource to facilitate an ability of the authorized beneficiaries to better receive benefits of services as are provided pursuant to the consideration-based private civil security subscriptions.

21. The method of claim 1 further comprising:
providing survival training content specifically designed for the authorized beneficiaries of consideration-based private civil security subscriptions that provide civilly-catastrophic event-based access to at least one life-sustaining resource to facilitate an ability of the authorized beneficiaries to receive reduced-consideration private civil security subscriptions.

22. The method of claim 1 wherein providing a plurality of private civil defense audio programs comprises, at least in part, gathering information regarding past, present, and potential civilly-catastrophic events and using the information regarding past, present, and potential civilly-catastrophic events to provide the plurality of private civil defense audio programs.

23. The method of claim 1 further comprising using the at least one dedicated civil defense-themed radio broadcast channel to transmit private survival information to the authorized beneficiaries such that at least some content of the private survival information is not discemable by the general program recipients.

24. The method of claim 23 further comprising providing the authorized beneficiaries with communication equipment operable to receive at least one dedicated private civil defense-themed radio broadcast channel, wherein the private survival information is discemable to authorized beneficiaries using the communication equipment.

25. The method of claim 23 further comprising:
correlating transmittable codes with corresponding survival information;
providing information regarding the transmittable codes to the authorized beneficiaries of the consideration-based private civil security subscriptions other than via the at least one dedicated private civil defense-themed radio broadcast channel;
using the at least one dedicated private civil defense-themed radio broadcast channel to transmit at least one of the transmittable codes to thereby provide private survival information to the authorized beneficiaries.

26. The method of claim 25 wherein the transmittable codes comprise audible codes.

27. The method of claim 25 wherein the transmittable codes are not discernable by any ordinary human sense.

28. The method of claim 23 further comprising:
correlating transmittable codes with corresponding survival information;
providing the authorized beneficiaries with communication equipment operable to receive at least one dedicated private civil defense-themed radio broadcast channel;
using the dedicated private civil defense-themed radio broadcast channel to transmit at least one of the transmittable codes; and
using the communication equipment to provide the authorized beneficiaries with a code-specific notice when the communication equipment receives at least one of the transmittable codes, thereby providing private survival information to the authorized beneficiaries.

29. The method of claim 28 further comprising:
providing information regarding the code-specific notice to the authorized beneficiaries of the consideration-based private civil security subscriptions other than via the dedicated private civil defense-themed radio broadcast channel.

30. The method of claim 28 where the code-specific notice comprises at least one of:
an alert;
the corresponding survival information;
at least one of the transmittable codes;
at least one code that is discemable by at least one ordinary human sense.

31. The method of claim 28 wherein:
the transmittable codes comprise encrypted private survival information; and
the communication equipment is configured and arranged to decrypt the transmittable codes.

32. The method of claim 28 wherein the transmittable codes comprise audible codes.

33. The method of claim 28 wherein the transmittable codes are not discernable by any ordinary human sense.

34. The method of claim 23 wherein using the at least one dedicated civil defense-themed radio broadcast channel to transmit private survival information to the authorized beneficiaries such that at least some content of the private survival information is not discernable by the general program recipients comprises transmitting the private survival information while simultaneously also transmitting one of the plurality of private civil defense audio programs on the same dedicated private civil defense-themed radio broadcast channel.

35. The method of claim 1 further comprising:
using at least one dedicated private civil defense-themed radio broadcast channel to transmit civilly-catastrophic event victim information.

36. The method of claim 35 wherein using at least one dedicated private civil defense-themed radio broadcast channel to transmit civilly-catastrophic event victim information comprises presenting the civilly-catastrophic event victim information in tandem with one of the plurality of private civil defense audio programs.

37. The method of claim 36 further comprising:
providing authorized beneficiaries with communication equipment operable to receive at least one dedicated private civil defense-themed radio broadcast channel; and
using the radio communication equipment to present the civilly-catastrophic event victim information visually.

38. The method of claim 35 wherein using at least one dedicated private civil defense-themed radio broadcast channel to transmit civilly-catastrophic event victim information comprises receiving the civilly-catastrophic event victim information from civilly-catastrophic event victims.

39. The method of claim 38 further comprising:
providing authorized beneficiaries with communication equipment; and
using the communication equipment to obtain information about the authorized beneficiaries.

40. The method of claim 39 wherein the information about the authorized beneficiaries comprises at least one of:
identification information;
contact information;
location information;
environmental condition information;
health condition information;
preferred destination information;
evacuation plan information.

41. The method of claim 1 wherein providing a plurality of private civil defense audio programs comprises providing a program presenting instructions regarding specific actions that a listener can take in a relatively immediate timeframe in order to better protect themselves from a given civilly-catastrophic event.

42. The method of claim 41 wherein providing a program presenting instructions regarding specific actions that a listener can take comprises providing a program presenting instructions regarding formulation of an emergency shelter that the listener can form using substantially only commonly available household items, to thereby facilitate preparation of such a shelter to thereby facilitate protecting the listener from a given civilly-catastrophic event.

43. The method of claim 41 wherein providing a program presenting instruction regarding specific actions that a listener can take comprises providing a program presenting instructions for survival in a wilderness environment.

44. The method of claim 1 further comprising:
providing the authorized beneficiaries with communication equipment operable to receive at least one dedicated private civil defense-themed radio broadcast channel.

45. The method of claim 44 further comprising:
using the communication equipment operable to receive at least one dedicated private civil defense-themed radio broadcast channel to facilitate two-way communication between the authorized beneficiaries and at least one of:
other authorized beneficiaries,
a private civil-defense service;
a public emergency service;
a public member.

46. The method of claim 1 wherein using at least one dedicated private civil defense-themed radio broadcast channel to transmit the plurality of private civil defense audio programs comprises using non-terrestrial radio transmission equipment.

47. The method of claim 1 wherein the private civil defense information regarding specific recommended actions for specific individuals with respect to a present civilly-catastrophic event scenario further comprises detailed information regarding specific geographic areas affected by an immediate civilly-catastrophic event.

48. The method of claim 1 further comprising:
providing supplemental programming other than via the dedicated private civil defense-themed radio broadcast channel; and
at least one of the private civil defense audio programs comprises information regarding the supplemental programming.

49. The method of claim 48 wherein the supplemental programming comprises at least one of:
visual programming;
audiovisual programming.

50. The method of claim 48 wherein providing supplemental programming other than via the dedicated private civil-defense themed radio broadcast channel comprises providing supplemental programming via at least one of:
a computer based network;
a television broadcast;
printed media.
